(19) United States
(12) Patent Application Publication
(10) Pub. No.: US 2015/0120392 A1
(43) Pub. Date: Apr. 30, 2015

(54) Ranking of Store Locations Using Separable Features of Traffic Counts

(71) Applicant: Cellco Partnership (d/b/a Verizon Wireless), Arlington, VA (US)

(72) Inventors: Nader Gharachorloo, Ossining, NY (US); Farshid Mostoufi, Alpharetta, GA (US)

(73) Assignee: Cellco Partnership (d/b/a Verizon Wireless), Arlington, VA (US)

(21) Appl. No.: 14/063,805

(22) Filed: Oct. 25, 2013

(51) Int. Cl. G06Q 10/06; G06Q 30/02

(52) U.S. Cl. CPC G06Q 10/0639; G06Q 30/0205; G06Q 30/0201
USPC 705/7.34

(57) ABSTRACT

A system may generate a matrix according to subscriber count data for a plurality of points of interest within a geographical area over a period of time identified from aggregate subscriber data, the matrix including counts per subset of the period of time arranged according to subset of the period of time and point of interest. The system may further perform a factorization of the matrix of subscriber counts to extract feature components of the subscriber count data, identify at least a primary feature component and a secondary feature component according to the factorization, and provide a ranking of at least a subset of the points of interest according to at least one of the primary feature component and the secondary feature component. The system may also receive a request for a report, generate the report according to the identified feature components, and provide the report responsive to a request.

### BACKGROUND

Some store locations may perform better than others. For example, some locations may be busier overall, while other locations may have peak traffic on different days of the week. Moreover, some locations may cater to different audiences or may experience differences in traffic due to advertising or other uncharacterized external factors. While a business may monitor daily cash flow, it may be difficult for the business to obtain good information to use to model patterns of customer behavior.

### BRIEF DESCRIPTION OF THE DRAWINGS

FIG. 1 illustrates an exemplary system for determining feature components for points of interest based on collected data from subscriber network devices.

FIG. 2 illustrates an exemplary analysis of a matrix of subscriber count data from which underlying feature components may be extracted.

FIGS. 3A and 3B illustrate exemplary reports depicting primary and other feature components of a plurality of points of interest in urban and suburban regions.

FIGS. 4A and 4B illustrate exemplary reports depicting variations in feature components of a plurality of points of interest in the urban region.

FIGS. 5A and 5B illustrate exemplary reports depicting holiday bumps for exemplary points of interest.

FIGS. 6A and 6B illustrate exemplary mappings of points of interest ranked according to feature components to depict event effects on traffic counts.

FIGS. 7A-7D illustrate exemplary reports depicting additional information that may be identified from analysis of variations in the feature components of a plurality of points of interest.

FIG. 8 illustrates an exemplary process for determining feature components for points of interest data based on collected data from subscriber network devices.

FIG. 9 illustrates an exemplary process for providing reports based on determined feature components.

### DETAILED DESCRIPTION

An advertising system may determine subscriber counts indicative of subscriber presence near various points of interest, and may perform analysis on the determined subscriber counts to identify common or differentiating features in traffic patterns at the points of interest. These features may be used to build a model of customer behavior, which may in turn be used to identify past traffic flows and predict future traffic flows at the points of interest.

To identify the features, the advertising system may generate and analyze a matrix including subscriber count data for a plurality of points of interest within a geographical area. For instance, the matrix may include counts per time period arranged according to time period and point of interest, where each row of the matrix represents daily counts of subscriber traffic at a point of interest, each column represents a single time period of daily counts across the points of interest, and each cell represents the subscriber count for the given location and day. Using the matrix, the advertising system may perform a factorization of the included subscriber counts to extract features of the subscriber count data. In some examples, the factorization of the matrix may be performed according to a principal component analysis technique to identify linearly uncorrelated variables in the matrix data, such as by using singular value decomposition. Based on the factorization, the advertising system may identify one or more features of the subscriber counts in relation to the points of interest.

As one example, the advertising system may identify a primary feature indicative of a variation in average weekly pattern of subscriber counts across each of the plurality of points of interest. Using the primary feature information, the advertising system may model aspects of traffic flow for a point of interest, such as a busiest day of the week, a slowest day of the week, and an overall weekly “beat” traffic pattern. As another example, the advertising system may identify a secondary feature indicative of a variation in the variation of the average weekly pattern of subscriber counts. Using the secondary feature information, the advertising system may model aspects of the traffic flow such as amounts of weekend and holiday variation in the subscriber counts. As a further example, the advertising system may identify a tertiary feature indicative of other independent variation of the average weekly pattern of subscriber counts. Using the tertiary feature information, the advertising system may model aspects of traffic flow such as a localized event (e.g., a sports game of importance to one community over another reducing traffic) and a variation in holiday celebration in the subscriber counts (e.g., indicative of a holiday observed by more consumers in one locality than in another).

To generate the subscriber count data, the advertising system may utilize a data warehouse to aggregate data regarding mobile subscribers who visit the various points of interest. For example, a network service provider may collect data when mobile subscriber devices send or receive calls, send or receive text messages, or browse or use mobile applications on their mobile devices (e.g., what sites were visited, what applications were used, lengths of time spend performing the usage). The network service provider may further collect information indicative of where the mobile subscriber devices were located during the network usage, thereby generating location information indicative of which subscribers visited what points of interest at what times. Moreover, the data warehouse may be further configured to analyze the collected web and application usage data to determine preferences or other characteristics of the subscribers based on what websites or other content the subscribers were accessing on their subscriber devices. By combining the application usage data locations with the network usage data and web and other supplemental information such as subscriber demographics, the data warehouse may accordingly generate aggregate subscriber data including demographic information and other preferences of the audience of subscribers who visit the points of interest. To ensure privacy of the subscribers whose information is included in reports, the system may remove subscriber identifiable information (e.g., names and phone numbers) from the subscriber information. Note that to the extent the various embodiments herein collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Based on the determined feature information, the advertising system may be configured to respond to requests for reports regarding the features of subscriber counts for various points of interest. The advertising system may be configured to receive requests for feature components of the points of interest specifying a geographic area and period of time, and may produce reports including the identified feature components, thereby providing information that may be used to build a model of customer behavior at the points of interest, as well as to facilities the ranking and analysis of different feature components of the traffic flows at the points of interest. Moreover, based on the ranking and analysis, the advertising system may be further configured to send notifications over the subscriber network to at least one of the points of interest, the notification including a suggested course of action for the point of interest determined according to the ranking (e.g., to adjust staffing or inventor levels at the point of interest).

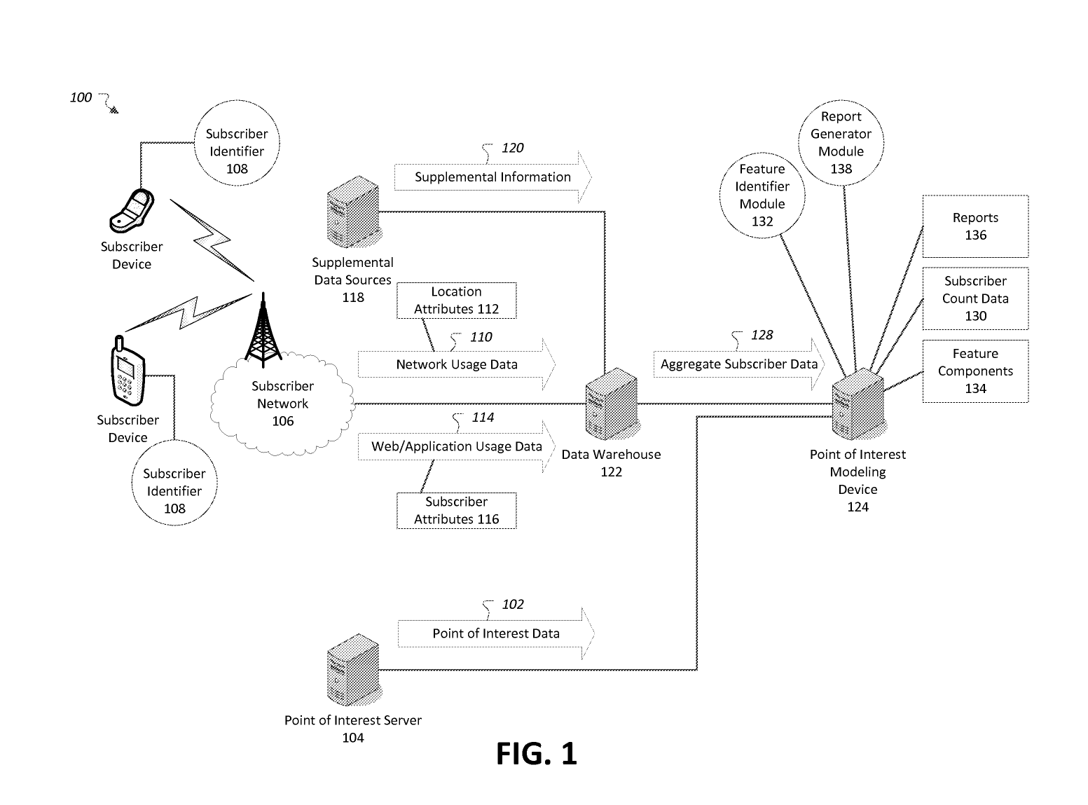

FIG. 1 illustrates an exemplary system 100 for determining feature components 134 for points of interest data 102 based on collected data from subscriber network 106 devices. The system may include a point of interest server 104 configured to provide point of interest data 102. The system 100 may further include a subscriber network 106 configured to provide communications services to a plurality of subscriber devices, and to generate network usage data 110 and web and application usage data 114 based on the provided services. The data warehouse 122 may be configured to assign location attributes 112 to the network usage data 110, assign subscriber attributes 116 to the received web and application usage data 114, receive supplemental information 120 from supplemental data sources 118 and process the received data into aggregate subscriber data 128 matched by subscriber identifiers 108. The system 100 may also include a point of interest modeling device 124 configured to utilize a feature identifier module 132 to generate subscriber count data 130 indicative of which points of interest are visited by which subscribers, and determine feature components 134 based on the subscriber count data 130. The point of interest modeling device 124 may also include a report generator module 138 configured to receive requests for reports 136 specifying a geographical area and period of time, and generate the reports 136 based on the determined feature components 134. The system 100 may take many different forms and include multiple and/or alternate components and facilities. While an exemplary system 100 is shown in FIG. 1, the exemplary components illustrated in Figure are not intended to be limiting. Indeed, additional or alternative components and/or implementations may be used.

The point of interest data 102 may include information related to various locations of interest that may be visited by a population of consumers. The point of interest server 104 may be configured to maintain point of interest data 102 regarding various the points of interest. As some examples, the point of interest data 102 maintained by the point of interest server 104 may include geographic locations of the point of interest (e.g., latitude and longitude, GPS coordinates, etc.), names of the points of interest (e.g., coffeehouses in general, Starbucks® coffeehouses, discount retailers, Wal-Mart®, etc.), and categories of point of interest (e.g., Coffeehouses, Discount Retailers, etc.).

The subscriber network 106 may provide communications services, such as packet-switched network services (e.g., Internet access, VoIP communication services) and location services (e.g., device positioning), to devices connected to the subscriber network 106. Exemplary subscriber networks 106 may include a VoIP network, a VoLTE (Voice over LTE) network, a cellular telephone network, a fiber optic network, and a cable television network, as some non-limiting examples.

Subscriber devices on the subscriber network 106 may be associated with subscriber identifiers 108 used to unique identify the corresponding devices. Subscriber identifiers 108 may include various types of information sufficient to identify the identity of a subscriber or a subscriber device over the subscriber network 106, such as mobile device numbers (MDNs), mobile identification numbers (MINs), telephone numbers, common language location identifier (CLLI) codes, Internet protocol (IP) addresses, and universal resource identifiers (URIs), as some non-limiting examples. In some cases, subscriber devices may support multiple personas (e.g., a personal user persona for a subscriber's personal data, an enterprise/corporate persona for a subscriber's work data, etc.), such that a single subscriber device may be used by the subscriber for multiple purposes (e.g., for both business and personal use). To facilitate identification of the different personas by the network 106, each persona of the subscriber device may be associated with a different subscriber identifier 108. Thus, using the subscriber identifier 108 the subscriber network 106 may be configured to identify and separately track which persona of the device is being used to perform what actions over the subscriber network 106. Accordingly, the subscriber network 106 may use the subscriber identifiers 108 to discard data from personas that should not be tracked, such as business or government accounts. As yet another possibility, for subscriber accounts that include multiple devices (e.g., devices associated with parents, spouses, and children), the subscriber identifier 108 may be further used to link multiple devices to a single persona or subscriber.

The subscriber network 106 may generate data records representing usage of the subscriber network 106 by the subscriber devices, for purposes including billing and network traffic management. Exemplary network usage of the subscriber network 106 may include placing or receiving a telephone call, sending or receiving a text message, using the web browser to access Internet web pages, and interacting with a networked application in communication with a remote data store. A usage data record of a subscriber making use of the subscriber network 106 may be referred to herein as a transaction or transaction record. Usage records of transactions may include information indexed according to the subscriber identifier 108 of the device using the subscriber network 106. For example, data records of phone calls and SMS messages sent or received by a subscriber device may include the MDN of the originating device and of the destination devices.

The subscriber network 106 may be configured to capture network usage data 110 from various network elements. Network usage data 110 may include data captured when a subscriber is involved in a voice call over the subscriber network 106, sends or receives a text message over the subscriber network 106, or otherwise makes use of a data or voice service of the network to communicate with other subscriber devices accessible via the subscriber network 106. The network elements of the subscriber network 106 may include a collection of network switches or other devices throughout the subscriber network 106 configured to track and record these subscriber transactions, e.g., regarding usage of the subscriber network 106 services by subscriber communications devices for billing purposes. This data collected by the network switches or other devices may include, for example, bandwidth usage, usage duration, usage begin time, usage end time, line usage directionality, endpoint name and location, and quality of service, as some examples. The network usage data 110 may use the collected data to identify and include information regarding when the communications took place, as well as identifiers of the network switches or other devices throughout the subscriber network 106 from which location information may be determined. It should be noted that approximate times may be sufficient for inclusion in the network usage data 110 (e.g., rounded to the nearest second or five seconds), rather than the full precision of time information that may be captured by the subscriber network 106. Accordingly, the network usage data 110 may include records of subscriber actions typically recorded by the subscriber network 106 in the ordinary course of business.

The subscriber network 106 may further include a location identification module configured to receive network usage data 110 from the various network switches of the subscriber network 106, and determine the location fixes for collected items of network usage data 110, such as for calls or text messages. These location fixes may be used to associate the subscriber devices with point of interest data 102, to allow the system 100 to determine a count of a population of visitors to the points of interest. To do so, the location identification module may locate the network device; associate the device with a location, and extrapolate the total population and demographic composition of the subscribers of the network devices to correspond to the population at large.

One exemplary method for determining location information to include in network usage data 110 may be to use advanced forward link trilateration (AFLT), whereby a time difference of arrival technique is employed based on responses to signals received from multiple nearby base stations. The distances from the base stations may be estimated from round trip delay in the responses, thereby narrowing down the location information without requiring subscriber devices to be capable of global positioning systems (GPS) or other types of location identification. If available, GPS may additionally or alternately be used to provide location fixes for network usage data 110. Another method for determining location information to include in network usage data 110 is by way of identification of a communication being served by an antenna system (e.g., by access points each associated with unique access point identifiers) configured to operate in a confined and specific area, such as a section of a stadium or other venue. For example, identifying a subscriber device according to an access point identifier of the access point from which the subscriber device is being served may allow for determination of location data regarding the subscriber position within the venue with relatively high accuracy and precision.

The location fixes may include data such as latitude/longitude, a timestamp, a precision value (e.g., radius in meters), and an identifier of the associated subscriber device. The precision value of the location fixes may vary according to the precision of the mechanism used to determine the location of the subscriber device. For example, a GPS-derived location may include a precision value of approximately 5-30 meters, an AFLT-derived location may include a precision value of approximately 30-200 meters, and a time difference of arrival-derived location may include a precision value of approximately 100-200 meters, as some examples.

The location identification module may be configured to identify and associate the location fixes with the captured network usage data 110 to indicate locations of the subscriber devices when the records of network usage data 110 were captured. For example, the location identification module may be configured to associate the received network usage data 110 with corresponding location attributes 112 of roadway segments, geo-fence information related to the location of the underlying call or subscriber network 106 use, or associations of the transaction record with point of interest data 102, such as a store or other landmark at or nearby the indicated location.

The location identification module may model probabilities of subscribers being at various points of interest. For example, the location identification module may model subscriber distance from a center of a location fix as following a Gaussian (or other such as Lorentzian) distribution, such that the higher the distance, the lower the probability. Notably, since the probability of subscriber location depends on distance, the determination is rotationally invariant. A standard deviation may be set such that a cumulative probability of the subscriber being inside a circle with radius equal to the precision of the location fix and center equal to the center of the location fix may have a relatively large probability (e.g., 90%). It should be noted that there may be some ambiguity in the determined locations, such that for a single location fix, a subscriber may potentially be indicated as being at multiple different point of interest location attributes 116, each with an associated probability (e.g., a 30% change of being at a Starbucks, and a 25% chance of being at a Best Buy for a single location fix).

The subscriber network 106 may also be configured to capture web and application usage data 114 from various network elements. These network elements may include a collection of regional distribution centers or other devices throughout the subscriber network 106 containing equipment used to complete wireless mobile data requests to data services, such as websites or data repositories feeding data to device applications. The distribution centers may be configured to track subscriber transactions and record web and application usage data 114 regarding Internet usage of subscriber network 106 services by subscriber communications devices, e.g., as part of tracking subscriber usage to facilitate billing. In some cases, the distribution centers may be configured to perform more detailed data gathering than required for billing purposes, such as deep packet inspection to obtain details of hypertext transfer protocol (HTTP) header information or other information being requested or provided to the subscriber devices of the subscriber network 106. Thus, the distribution centers may be configured to capture web and application usage data 114 related to mobile internet usage by network service provider subscribers including data such as: end time of receiving information from a uniform resource locator (URL) address, duration of time spent at the URL, a (hashed or otherwise encrypted) identifier of the subscriber MDN, an indication of the HTTP method used (e.g., GET, POST), the URL being accessed, user agent strings (e.g., including device operating system, browser type and browser version), an indication of content type (e.g., text/html), a response code resulting from the HTTP method, a number bytes sent or received, an indication of a type of sub-network over which the usage was made (e.g., 3G, 4G), indications of usage of mobile applications, lengths of time spend performing browsing and application use, number of application downloads, and network topology location where the URL was accessed or the application was used or downloaded.

The subscriber network 106 may further include analytics functionality configured to assign categories to the URLs and applications used (e.g., “news”, “sports”, “real estate”, “social”, “travel”, “business”, “automotive”, etc.). For example, a visit to the CNN website may be assigned to a “news” category, while a visit to the ESPN website may be assigned to a “sports” category. The analytics functionality may be further configured to assign subscriber attributes 116 to the web and application usage data 114 records based on the category analysis. A subscriber attribute 116 may be indicative of a preference of the subscriber for content in a particular category of content. A subscriber may be associated with zero or more subscriber attributes 116. For example, the analytics functionality may analyze the processed web and application usage data 114 for a subscriber (e.g., keyed to a subscriber identifier 108 indicative of the subscriber device or subscriber persona of one or more subscriber devices) over a period of time (e.g., per day) to derive subscriber attributes 116 for that subscriber's (or persona's) records over the time period. For instance, a subscriber who has browsed several websites within the “sports” category during the day might be associated with a “sports enthusiast” subscriber attribute 116. As another example, a subscriber who frequents travel websites may be associated with a “business travel” subscriber attribute 116. As yet a further example, a subscriber who frequents discount websites may be associated with a “discount shopper” subscriber attribute 116. The analytics functionality may utilize various heuristics to determine how much subscriber activity may be required to associate a subscriber with a category. For example, the analytics functionality may utilize a minimum threshold number of visits to websites in a category to associate the subscriber with that category (e.g., three visits in a day), or a minimum threshold percent of visits to websites in the category (e.g., 15% of a subscriber's requests) to associate the subscriber with that category. In some cases, the analytics functionality may require subscriber activity for a category in a plurality of periods of time (e.g., over multiple days, such as three of the last twenty-eight days) in order to associate a subscriber with a category. In addition, these thresholds may vary according to the categories being associated with the subscribers. For instance, a travel enthusiast may have a lower threshold than sports enthusiast (e.g., two visits in a day to travel sites as compared to five visits in a day to sports website) because an expected amount of usage over the same time period to be associated with the category may vary from category to category. Moreover, the analytics functionality may update subscriber attributes 116 associated with the subscribers based on data received for later periods of time.

The system 100 may further include various additional supplemental data sources 118 configured to provide supplemental information 120 to the system 100 apart from subscriber usage of the subscriber network 106. As one example, a supplemental data source 118 may be configured to provide supplemental information 120 indicative of demographics regarding residents (e.g., census information, third-party compiled information from a vendor such as Experian™ or Acxiom™), in many cases broken down geographically (e.g., by state, zip code, Nielson designated market areas, etc.). As other examples, the supplemental data sources 118 may be configured to provide supplemental information 120 regarding subscribers based on their attributes (e.g., age, gender, race, income, primary language), as well as supplemental information 120 including road segment traffic count information for use in analysis of drivers or other travelers. As yet a further example, a supplemental data source 118 may include billing information regarding customer accounts of the subscriber network 106 that may include address, age, gender, or other accountholder information relevant to the system 100.

The data warehouse 122 may be configured to receive and maintain network usage data 110 and web and application usage data 114 from the subscriber network 106 as well as supplemental information 120 from the supplemental data sources 118. Before transmission to the data warehouse 122, the subscriber network 106 may be configured to utilize a hashing module to convert subscriber identifiers 108 included in the network usage data 110 and web and application usage data 114 (e.g., customer mobile numbers, origination MIN, dialed digits) into hashed identifiers using a pre-defined two-way encryption methodology. The data warehouse 122 may be configured to decrypt the data using the methodology, to allow for secure transmission of the network subscriber data from the subscriber network 106 to the data warehouse 122.

The data warehouse 122 may be further configured to correlate the received data by subscriber identifier 108 (e.g., MDNs of the subscriber devices, subscriber names, etc.), thereby providing combined information for the subscribers including subscriber location attributes 112 as well as related to subscriber attributes 116 and demographics. This correlated data may be referred to as aggregate subscriber data 128. As one possibility, the data warehouse 122 may be further configured to ensure subscriber anonymity in the aggregate subscriber data 128, for example, by removing subscriber identifiers 108 from the aggregate subscriber data 128.

The point of interest modeling device 124 may be configured to utilize a feature identifier module 132 to determine subscriber count data 130 indicative of subscriber presence near various points of interest based on the aggregate subscriber data 128, and may perform analysis on the determined subscriber count data 130 to identify common or differentiating features in the traffic patterns at the points of interest. These features may be used to build a model of customer behavior at the points of interest, which may be used to understand past and predict future traffic flows. The feature identifier module 132 may determine the subscriber count data 130, for example, by identifying in the aggregate subscriber data 128 a number of subscribers whose location attributes 112 are indicative of a particular point of interest within a given timeframe. In some cases, subscribers being counted may be filtered according to one or more subscriber attributes 116. For example, the feature identifier module 132 may determine the subscriber count data 130 for “sports enthusiasts,” “business travelers,” or “discount shoppers” based on the subscriber attributes 116.

The point of interest modeling device 124 may further utilize the feature identifier module 132 to generate and analyze a matrix including subscriber count data 130 for a plurality of points of interest within a geographical area. For instance, the matrix may be generated to include counts per time period arranged according to time period and point of interest. Using the matrix, the point of interest modeling device 124 may utilize a feature identifier module 132 to perform a factorization of the included subscriber count data 130 to extract features of the subscriber count data using a principal component analysis technique utilizing orthogonal transformation. In some examples, the principal component analysis factorization of the matrix may be performed using singular value decomposition. Based on the factorization, the point of interest modeling device 124 may identify one or more features of the subscriber counts in relation to the points of interest.

The point of interest modeling device 124 may be further configured to utilize a report generator module 138 to receive a request for a report 136 regarding the audience of one or more points of interest, query the aggregate subscriber data 128 for subscriber information for the indicated points of interest and time periods according to the subscriber count data 130, and provide the report 136 responsive to the request based on the resultant feature components 134. The generated ad unit report 136 may accordingly include the principal and other components as determined by the feature identifier module 132. As discussed in detail below, the principal feature component 148 may indicate an overall trend of traffic patterns over the plurality of points of interest being analyzed, and may provide information in the generated reports 136 regarding the points of interest, such as: a busiest day of the week, a slowest day of the week, and an overall weekly “beat” traffic pattern. Moreover, the other determined feature components 134 may indicate other information in the generated reports 136 regarding the points of interest differing from the overall trend, such as: a weekend variation in subscriber counts data 130, a holiday variation in the subscriber count data 130, effects of localized events on the subscriber count data 130, and effects of variation in holiday celebration in the subscriber counts 130.

An advertiser or point of interest owner may receive the report 136, and may use the information to model customer behavior in according to the resultant features. For example, a business may determine, based on the reports 136, to adjust staffing hours to accommodate identified fast and slow period of traffic (e.g., days or hours that require additional staffing or days or hours for which staffing may be reduced). As another possibility, the business may determine amounts of merchandise to have on hand to handle expected customer demand for various days of the week according to the reported traffic flows.

In some cases, subscribers who are business owners of points of interest or marketers may further utilize the report generator module 138 to set up reports 136 to be automatically scheduled to be generated or notifications to be automatically provided upon certain conditions being met. For example, a subscriber may configure the report generator module 138 to provide a periodic report 136 (e.g., weekly, monthly, etc.) regarding points of interest within a particular geographic area. The subscriber may associate the report generation with a subscriber identifier 108 of the subscriber, such that the subscriber identifier 108 may be notified of the report generation (e.g., by receipt of the report to the subscriber identifier 108 from the report generator module 138, by receipt of a text message or automated phone call to a compatible subscriber identifier 108 indicating that a new report is available for the subscriber to receive from the report generator module 138, etc.). As another example, a subscriber may configure the report generator module 138 to provide a notification when traffic count information varies from typical values, such as by a threshold percentage or other amount from that of a previous reporting period or average across multiple previous reporting periods. For instance, a subscriber may configure the report generator module 138 to provide a subscriber identifier 108 with a notification when a traffic level for a point of interest varies by more than 15 percent from the traffic level of the same point of interest and day for the prior week. As another possibility, a subscriber may configure the report generator module 138 to provide a subscriber identifier 108 with a notification when a traffic level for a point of interest outperforms or underperforms its relative ranking among other points of interest within a geographic area by more than a specified percentage, rank or traffic amount.

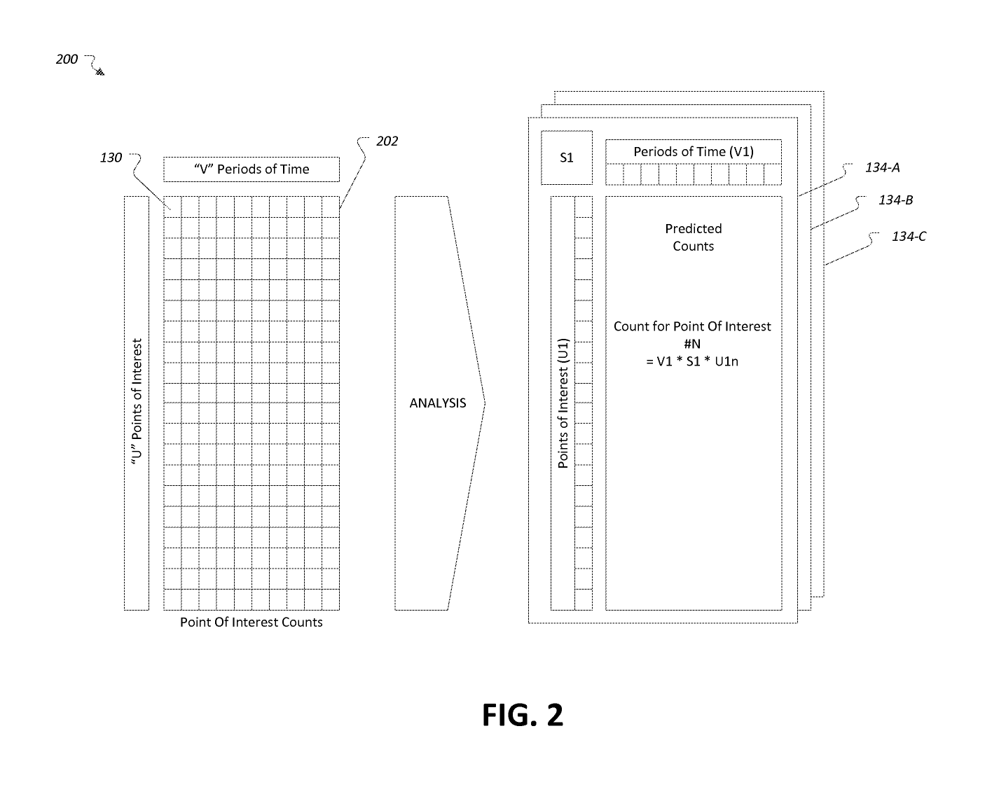

FIG. 2 illustrates an exemplary analysis 200 of a matrix 202 of subscriber count data 130 from which underlying feature components 134 may be extracted. As illustrated, the matrix 202 may include subscriber count data 130 for “U” points of interest, over “V” periods of time. Each row of the matrix 202 may accordingly represent periodic counts of subscriber traffic for one of the “U” points of interest, each column of the matrix 202 may represent a single period of time of counts across the points of interest, and each cell of the matrix 202 may represent a subscriber count data 130 amount for the given point of interest “U” and period of time “V.”

The feature identifier module 132 may perform principal component analysis on the matrix 202 to identify patterns in the subscriber count data 130 and determine feature components 134 that model the subscriber count data 130 with minimal loss of information. For example, the feature identifier module 132 may determine the mean data value across each dimension, and may subtract the mean form data value across each dimension to produce a data set with a mean of zero. The feature identifier module 132 may further perform singular value decomposition on the resultant matrix 202. Singular value decomposition operates based on a theorem that a rectangular matrix (such as the matrix 202) may be broken down into the product of an orthogonal matrix U, a diagonal matrix S, and the transpose of an orthogonal matrix V. For every M×N matrix, the theorem states that there exists a M×M orthogonal matric U and an N×N orthogonal matrix V, such that U^{T}AV is an M×N diagonal matrix Σ that has values σ₁≧σ₂≧ . . . _σ₁≧σ_{min{m,n}}≧0 in its diagonal. Thus, every matrix A has a decomposition A=UΣV^{T} such that the values σᵢ are the singular values of A, the columns of U are the left singular vectors, and the columns of V are the right singular vectors of A.

The feature identifier module 132 may be further configured to interpret the columns of U or V to determine factors of information regarding the matrix 202. For instance, if two columns have similar values in a row of V^{T}, then these attributes may be identified as being similar in some matter, i.e., having a relatively stronger correlation. As another example, if two rows have similar values in a column of U, then these elements may also be similar in some manner. Moreover, the singular vectors give the dimensions of the variance in the data, such that the first singular vector is the dimension of the largest variance, the second singular vector is the orthogonal dimension of the second largest variance, and so on. The feature identifier module 132 may make use of one or more mathematical libraries to perform the singular value decomposition, such as the Apache commons Math library repository of reusable Java components distributed by the Apache Software Foundation, or the SVDLIBC C-language library maintained by the Language Laboratory of the Massachusetts Institute of Technology.

As illustrated in the analysis 200, the decomposition A=UΣV^{T} may be rewritten as a sum of a rank-1 layers, e.g., as Aᵢ=σᵢ vᵢ uᵢ^{T}, such that the first layer explains the data as a first approximation, the second layer corrects the first approximation by adding and removing values that are smaller on average than for the first layer, the third layer corrects that by adding and removing still smaller values, and so on. In some cases, only a subset of the layers are considered, such that the considered layers include at least a minimum percentage of the variation in the overall data set (e.g., 90% of the overall variation).

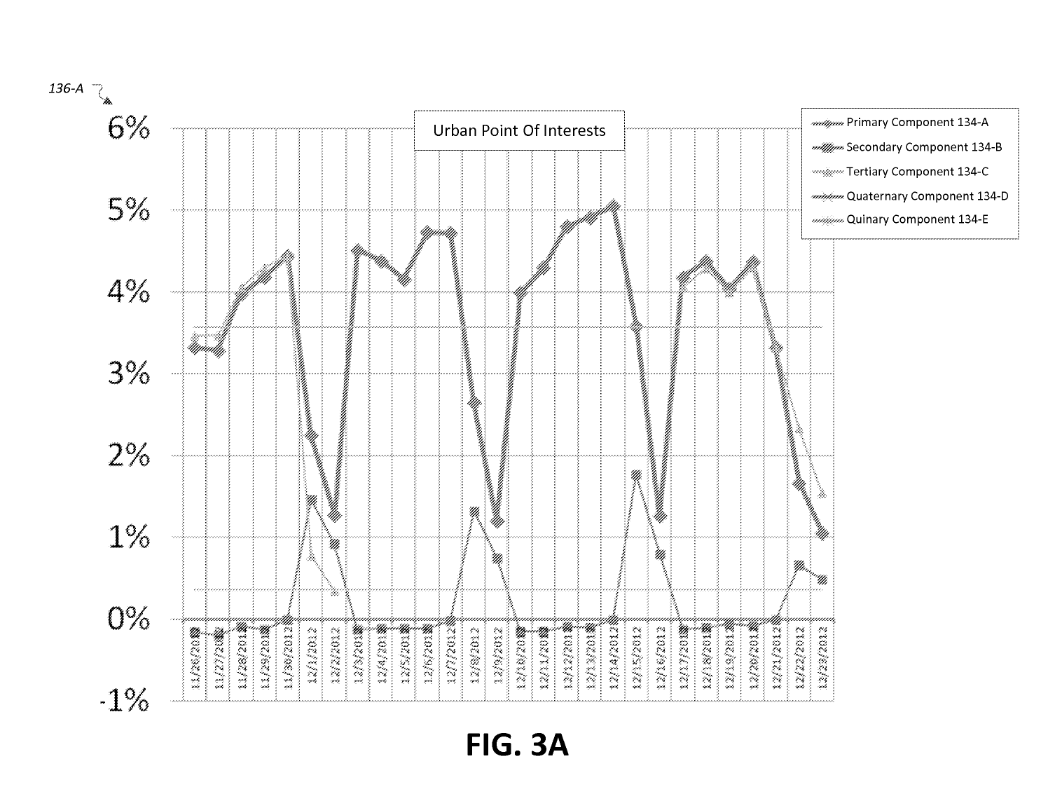

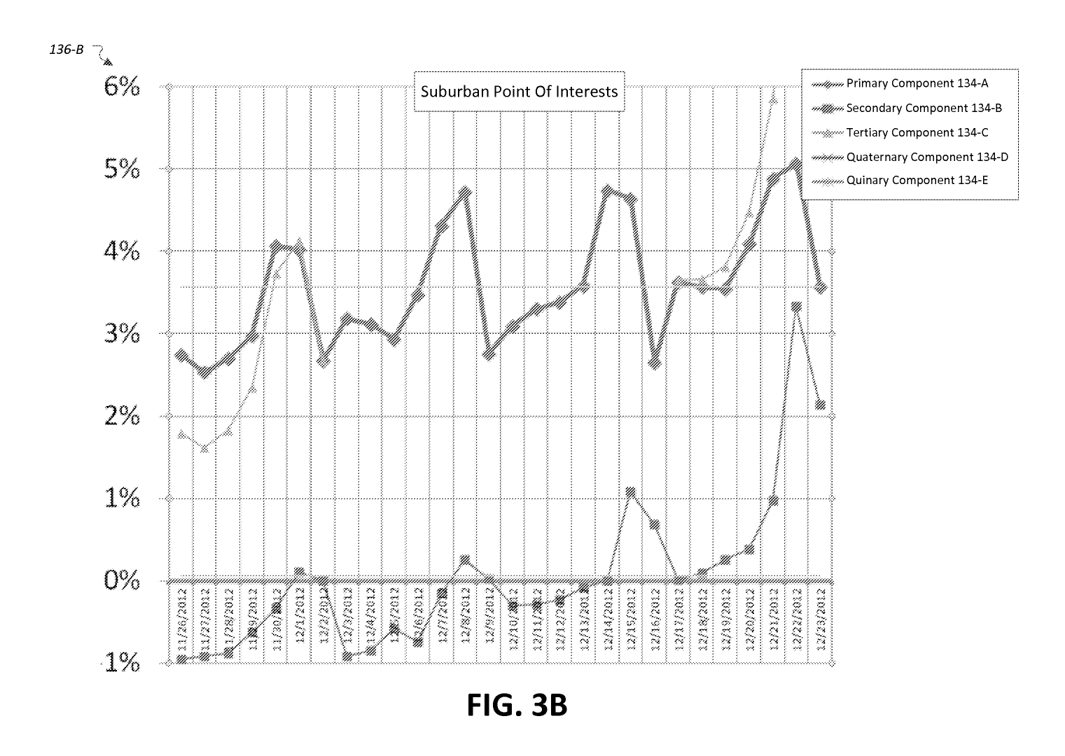

FIGS. 3A and 3B illustrate exemplary reports 136-A and 136-B depicting graphical representation of primary and other feature components 134-A through 134-E (collectively 134) of a plurality of points of interest in an urban region as compared to suburban regions. The feature components 134 for the reports 136-A and 136-B may be determined, for example, by the feature identifier module 132 performing principal component analysis on subscriber count data 130 for a plurality of urban and suburban points of interest over a specified time period. As illustrated, the report 136-A includes feature components 134 determined for an urban point of interest, e.g., for a particular chain of coffeehouse locations (or coffeehouses in general) in Manhattan over the weeks of a year from Thanksgiving to Christmas, while the report 136-B illustrates feature components 134 over the same time period, but for suburban coffeehouse points of interest.

The primary or principal feature component 134-A illustrates the overall trend of traffic patterns over the plurality of points of interest being analyzed. For example, while the scale of the difference may differ among points of interest, an increase in the primary feature component 134-A for a period of time indicates that traffic over the points of interest generally increased over that period of time, and a decrease over the period of time indicates that traffic over the points of interest generally decreased.

Within that generally rising or falling pattern, some points of interest may have traffic patterns that rise more or less than indicated by the primary feature component 134-A. These differences may be indicated by the secondary feature component 134-B. Thus, the secondary feature component 134-B may specify over the same period of time a differentiation from the primary feature component 134-A trend shared by the points of interest. A relatively small secondary feature component 134-B may indicate that the point of interest substantially follows the primary feature component 134-A trend, while a greater secondary feature component 134-B indicates that there is a greater difference from the primary trend. The tertiary feature component 134-C may similarly specify further differences from the primary feature component 134-A and the secondary feature component 134-B, and the quaternary feature component 134-D and quinary component 134-E may similarly specify yet further, smaller, differences.

Referring more specifically to the urban point of interest data of the report 136-A, the primary component 134-A may be observed to have a clear weekly beat pattern, with relatively busier weekdays (especially Fridays) and relatively less busy weekends. Moreover, the report 136-A may further illustrate a relatively large range of traffic in the primary component 134-A between the high traffic weekdays as compared to the traffic lows of Saturday and Sunday.

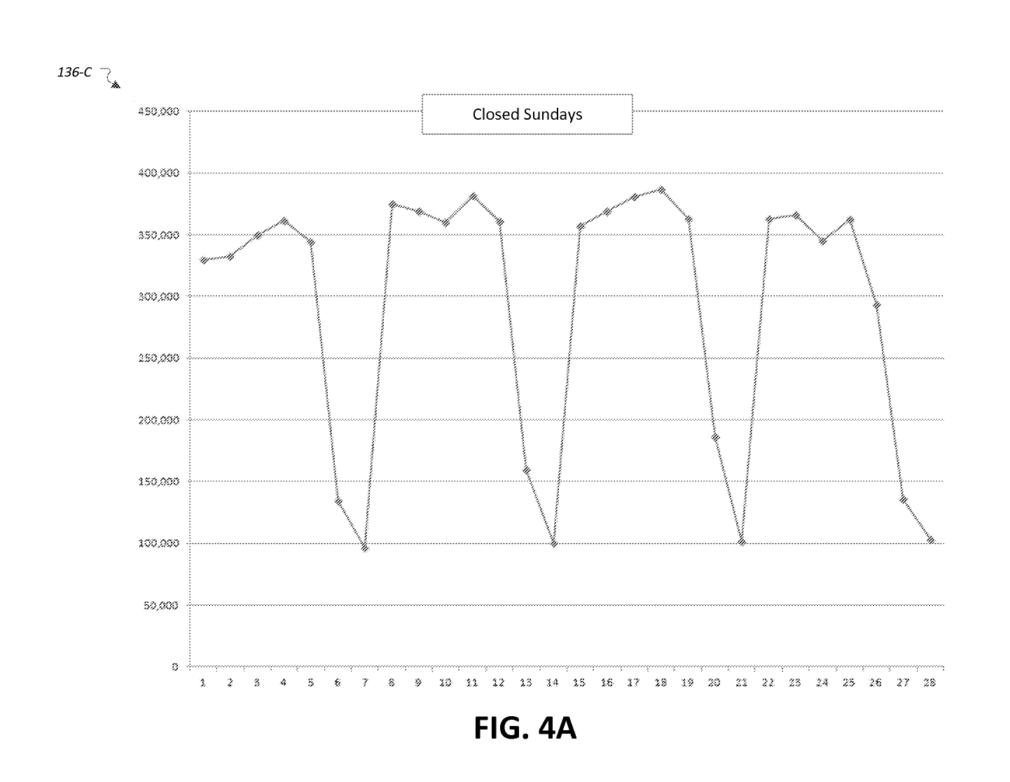

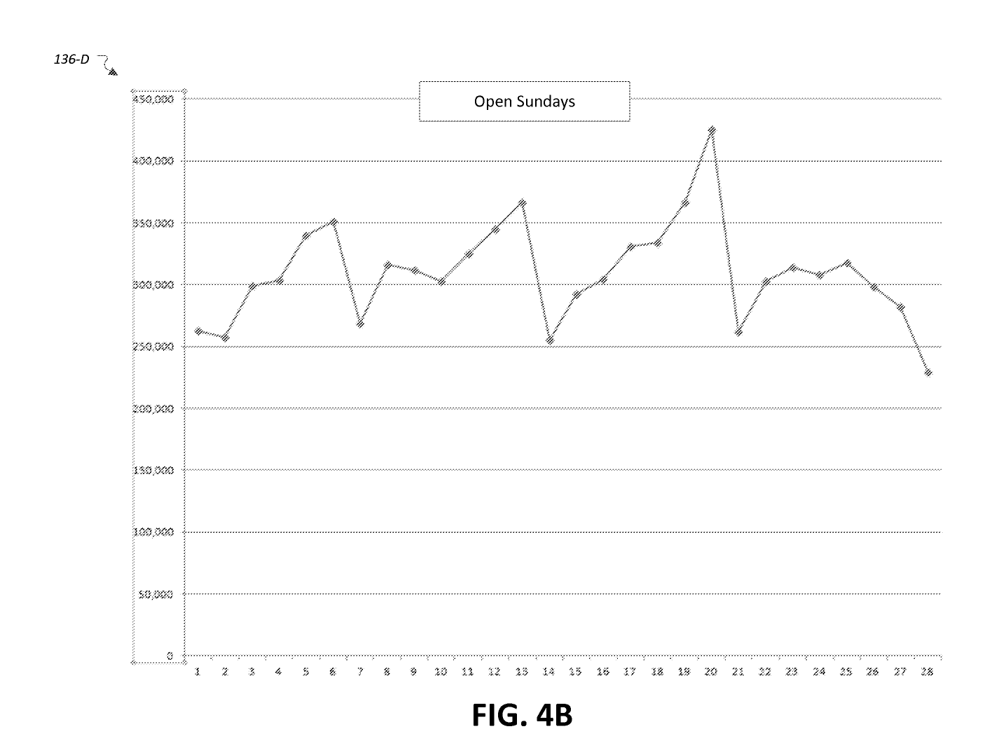

As another aspect of the report 136-A, the secondary component 134-B indicates a variation in the level of weekly slowdown for the indicated coffeehouse point of interest location. Notably, the secondary component 134-B is relatively small during the week, indicating that the points of interest mostly follow the primary trend during the week. However, on the weekends, further differences appear, perhaps based on differences between those points of interest that substantially serve weekday office traffic only, as compared to those points of interest with more substantial residential space nearby that serve additional weekend traffic. Further aspects of urban location analysis are discussed in detail below with respect to FIGS. 4A and 4B.

As illustrated in the report 136-B, the suburban New York coffeehouse point of interest locations have a substantially different, but also clear beat pattern in the primary component 134-A, with slow Sundays but busy Fridays and Saturdays. As opposed to the primary component 134-A in the report 136-A, the primary component 134-A includes a relatively narrower range of traffic between high traffic and low traffic days.

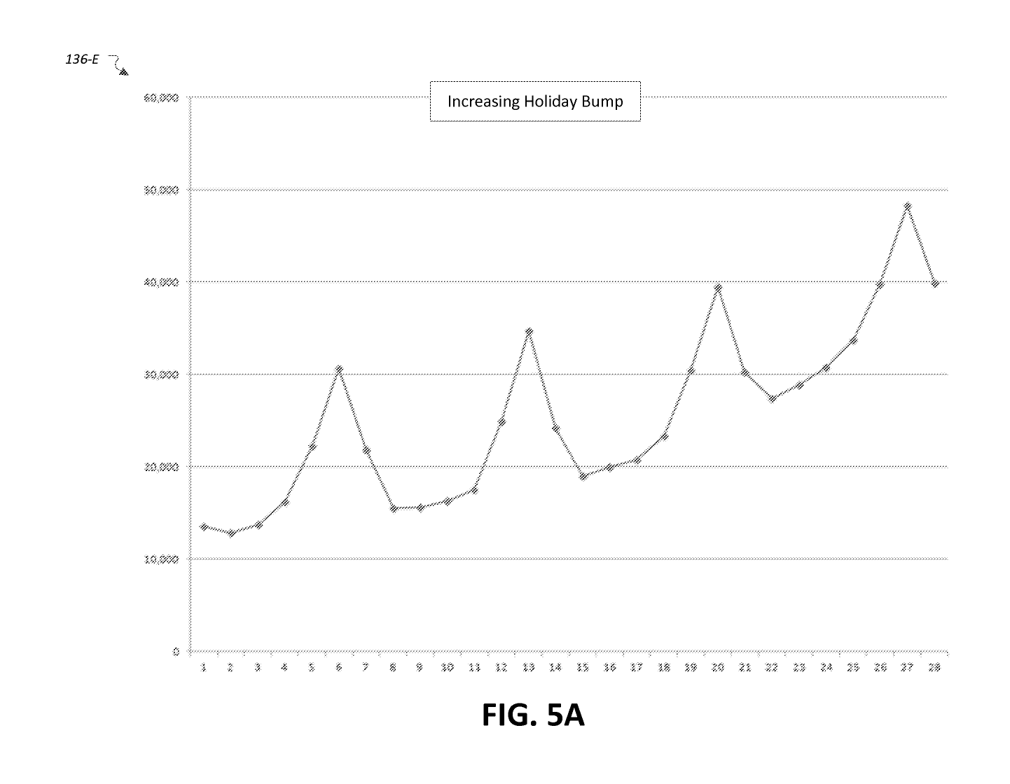

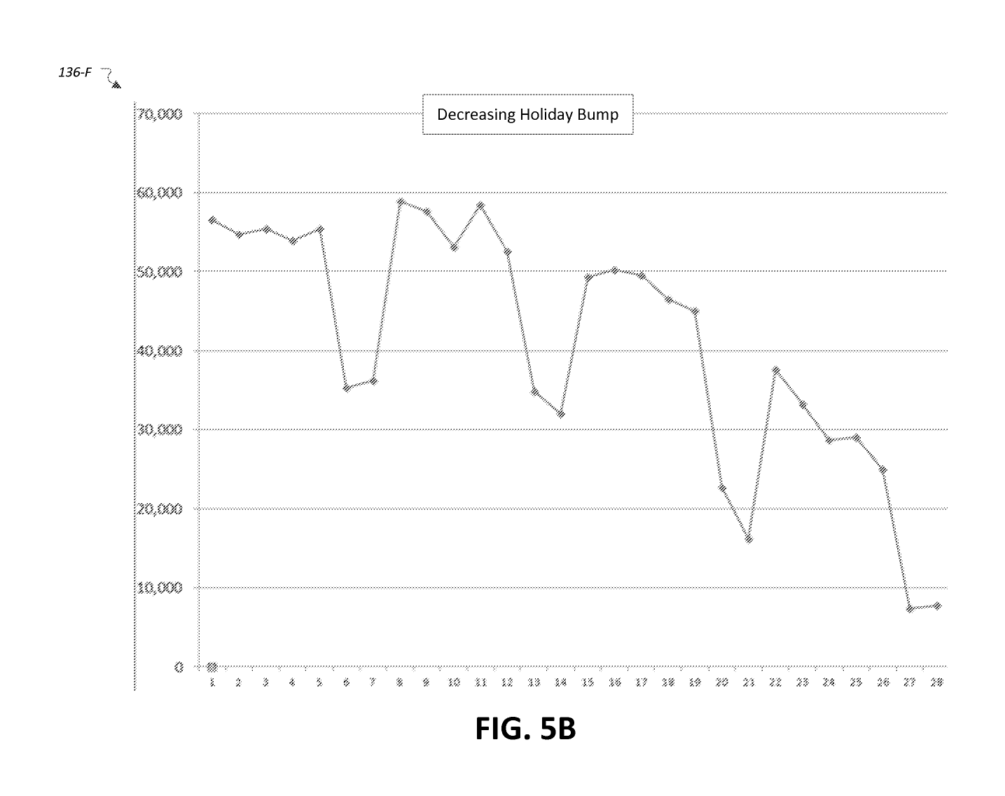

With respect to the secondary variations over the indicated end of year timeframe, a ramping up, or holiday bump, may be observed in the secondary component 134-B indicative of a general upward trend for the particular coffeehouse location beyond that of the typical weekly beat pattern of the primary component 134-B. Notably, no holiday bump appears present in the secondary component 134-B of the report 136-A discussed above, as traffic volumes for urban commuters do not increase towards the Christmas holiday. Further aspects of the holiday bump analysis are discussed in detail below with respect to FIGS. 5A and 5B.

Based on these differences of urban vs. suburban coffeehouse locations, the reports 136-A and 136-B may serve as a model for predicting expected traffic patterns for the same or other urban or suburban coffeehouse locations. For example, traffic trends at a Starbuck location in downtown Phoenix, AZ may be modeled using the feature components 134 determined for urban New York City coffeehouse locations, while traffic trends at a Starbuck location in suburban Phoenix may be modeled using the feature components 134 determined for suburban New York State coffeehouse locations.

FIGS. 4A and 4B illustrate exemplary reports 136-C and 136-D depicting further analysis of variations in the feature components 134 of a plurality of points of interest in the urban region. By analyzing differences in the secondary component 134-B, the feature identifier module 132 may rank the points of interest by magnitude of secondary component 134-B, and identify those points of interest with the most negative secondary component 134-B and the most positive secondary component 134-B. These differences may be used to inform regarding additional aspects of traffic behavior.

For instance, the most negative secondary components 134-B with the most reduced Sunday traffic flow for urban points of interest may be indicative of locations that are closed on Sunday (e.g., the report 136-C) while the most positive secondary components 134-B may be indicative of those points of interest that are open Sundays (e.g., the report 136-D). As one example, the exemplary report 136-C illustrates traffic flow information for a particular urban coffeehouse location that is closed on Sundays (e.g., a coffeehouse at 45^{th} and Park in New York City), while the report 136-D illustrates traffic flow information for a particular urban coffeehouse location that is open on Sundays (e.g., a coffeehouse at 1585 Broadway in Times Square, a coffeehouse at 10 Union Square East). Notably, while these locations are approximately three blocks apart, the differences in traffic patterns are significant. Moreover, the model may further illustrate from the report 136-D that the urban coffeehouse locations that remain open Sundays are busy above average for a Sunday coffeehouse location generally, potentially due to the reduction in other available options.

FIGS. 5A and 5B illustrate exemplary reports 136-E and 136-F, respectively, including graphical representations of holiday bumps for exemplary points of interest. Based on the model identified above in the exemplary report 136-B, and by analyzing differences in the secondary components 134-B, the feature identifier module 132 may rank the points of interest by magnitude of secondary component 134-B and use the information to determine which point of interest locations experience the largest or smallest holiday bumps.

The report 136-E illustrates an exemplary point of interest displaying a relatively high secondary component 134-B ranking and correspondingly large positive holiday bump. For example, a holiday bump secondary component 134-B similar to those of the report 136-E may be identified for a point of interest located at or near a mall or other shopping area experiencing additional holiday traffic, e.g., leading up to the Christmas holiday.

In contrast, the report 136-F an exemplary point of interest displaying a relatively low secondary component 134-B ranking and correspondingly large negative holiday bump. For example, a holiday bump secondary component 134-B similar to those of the report 136-F may be identified for a point of interest located at or near a college campus or other area in which population may be reduced for leading up to holidays, e.g., again leading up to the Christmas holiday. Using these observations, a model of point of interest behavior may be augmented to predict positive or negative secondary components 134-B based on proximity of the point of interest to shopping malls or college campuses.

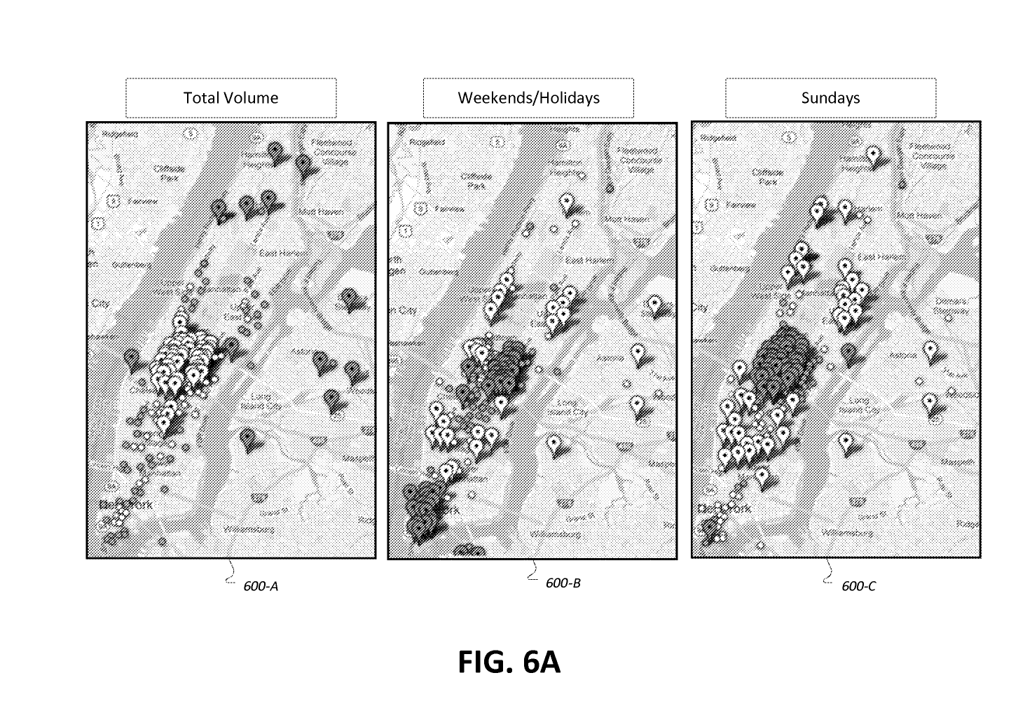

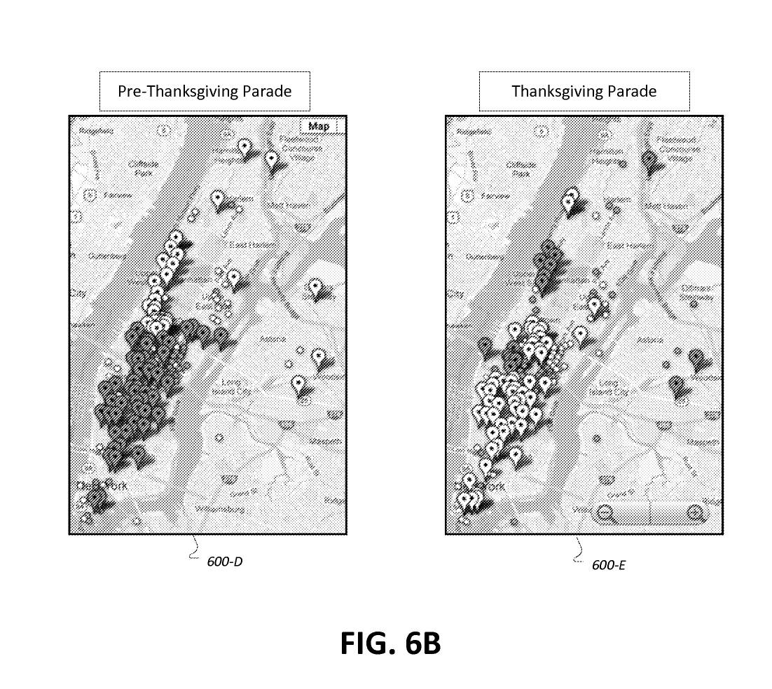

FIGS. 6A and 6B illustrate exemplary mappings 600 of points of interest ranked according to components 134 to depict event effects on traffic counts. The feature identifier module 132 may rank the points of interest by various factors, such as according to one or more of the feature components 134, or by overall traffic volume over various period of time.

FIG. 6A illustrates exemplary mappings 600 of points of interest ranked according to traffic data over a multiple week period. As an example, the ranked traffic levels may be divided into four categories by quartile, such that each group includes a quarter of the data (e.g., large and light for most busy, small and light for above average, small and dark for below average, and large and dark for most below average). In other examples, different breakdowns of the ranked traffic levels are possible, including more or fewer than four categories, or different category definitions, such as number of standard deviations from an average data value. The mapping 600-A illustrates a mapping ranked according to total volume over the period of time, while the mapping 600-B illustrates a ranking of weekends and holidays and the mapping 600-C illustrates a ranking of Sundays only. As can be seen, while Midtown is the most busy in terms of overall traffic, in confirmation of the model that residential areas are busier than business areas during non-business days, the residential areas near Central Park and the Upper East Side are relatively more busy on holidays (and especially on Sundays) than the New York City business districts.

FIG. 6B illustrates an exemplary mapping of points of interest ranked according to traffic data relating to a one-time event. As with the mappings 600-A through 600-C, the ranked traffic levels in the mappings 600-D and 600-E may be divided into four categories (e.g., large and light for most busy, small and light for above average, small and dark for below average, and large and dark for most below average). The mapping 600-D illustrates a ranking of the points of interest according to total volume during the time period of the night before the Thanksgiving day parade, while the mapping 600-E illustrates a ranking of the points of interest during the time period during the Thanksgiving Day parade. Notably, there is an unusually large amount of traffic in the area Northwest of Central Park, as that location is where Thanksgiving Day balloons are set up for parade. Moreover, the relatively higher traffic areas during the parade are consistent with the Thanksgiving Day parade route.

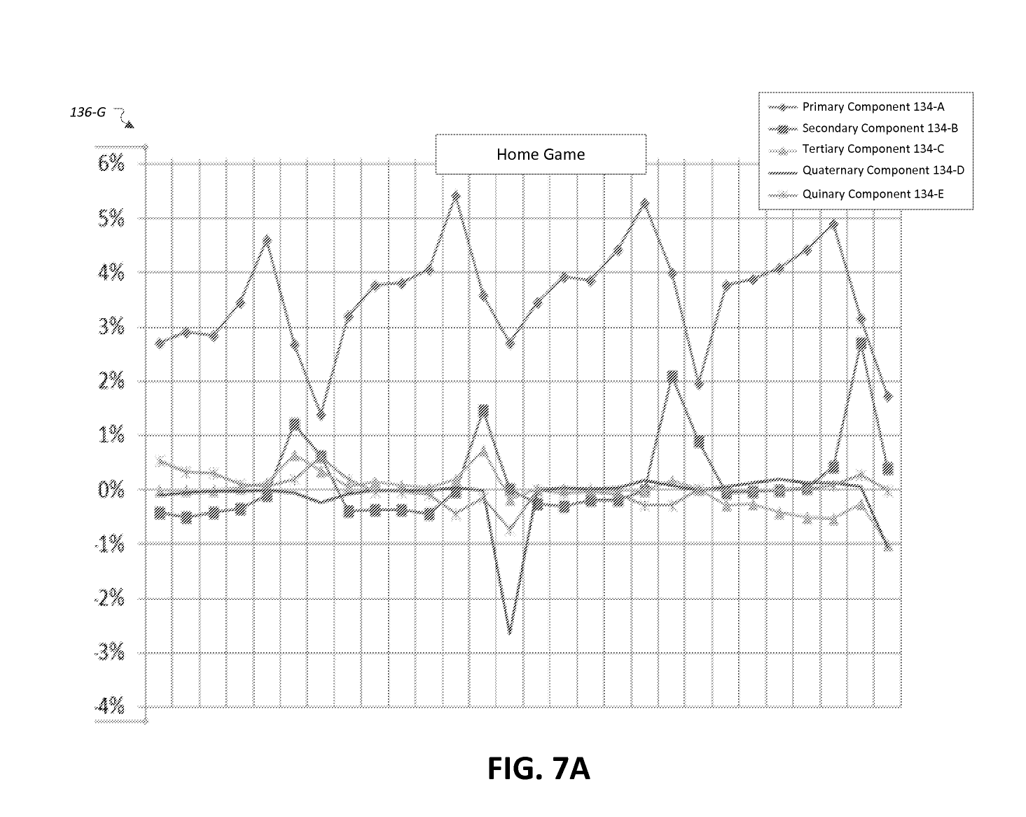

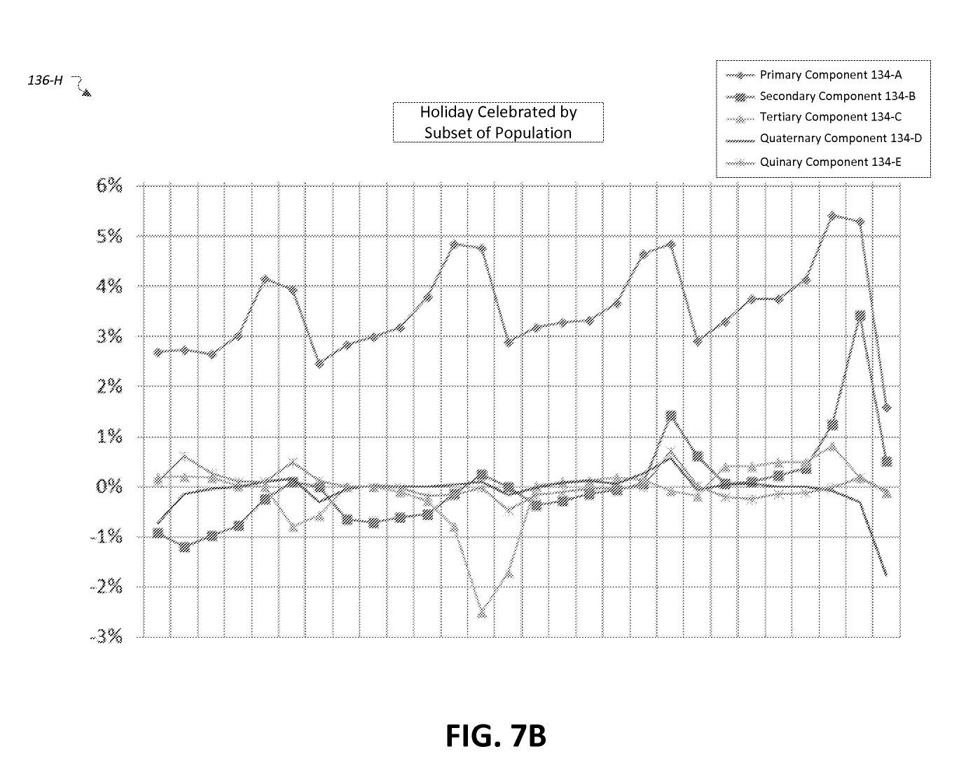

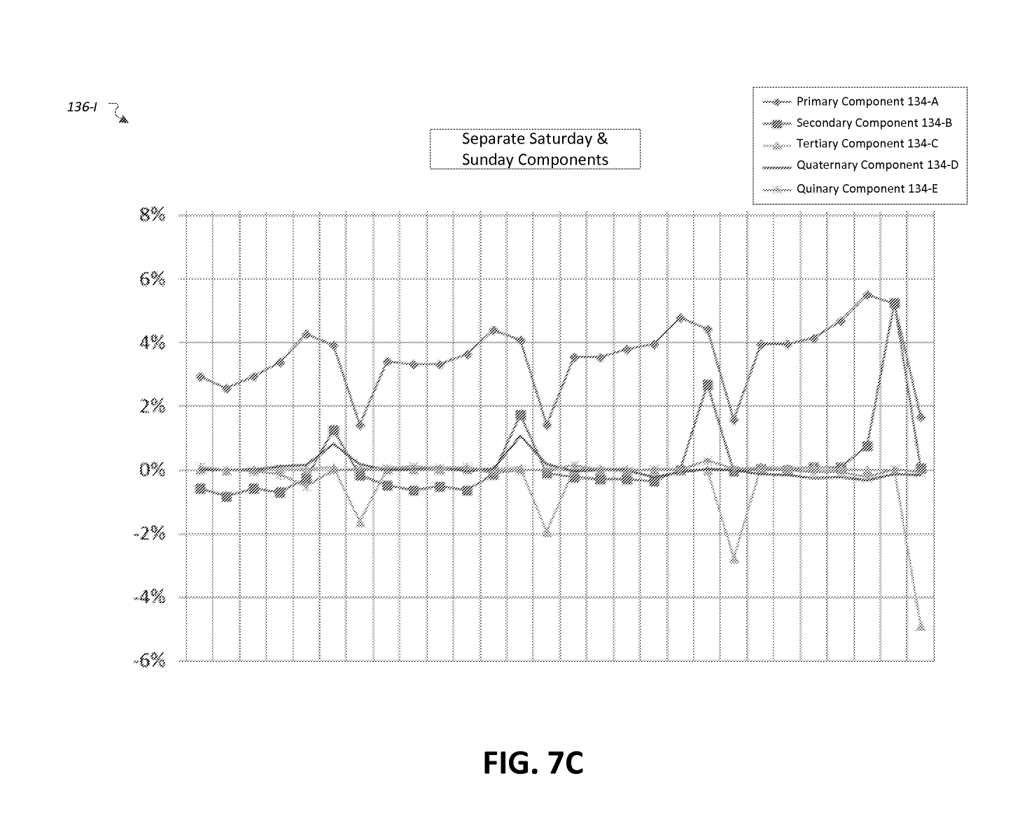

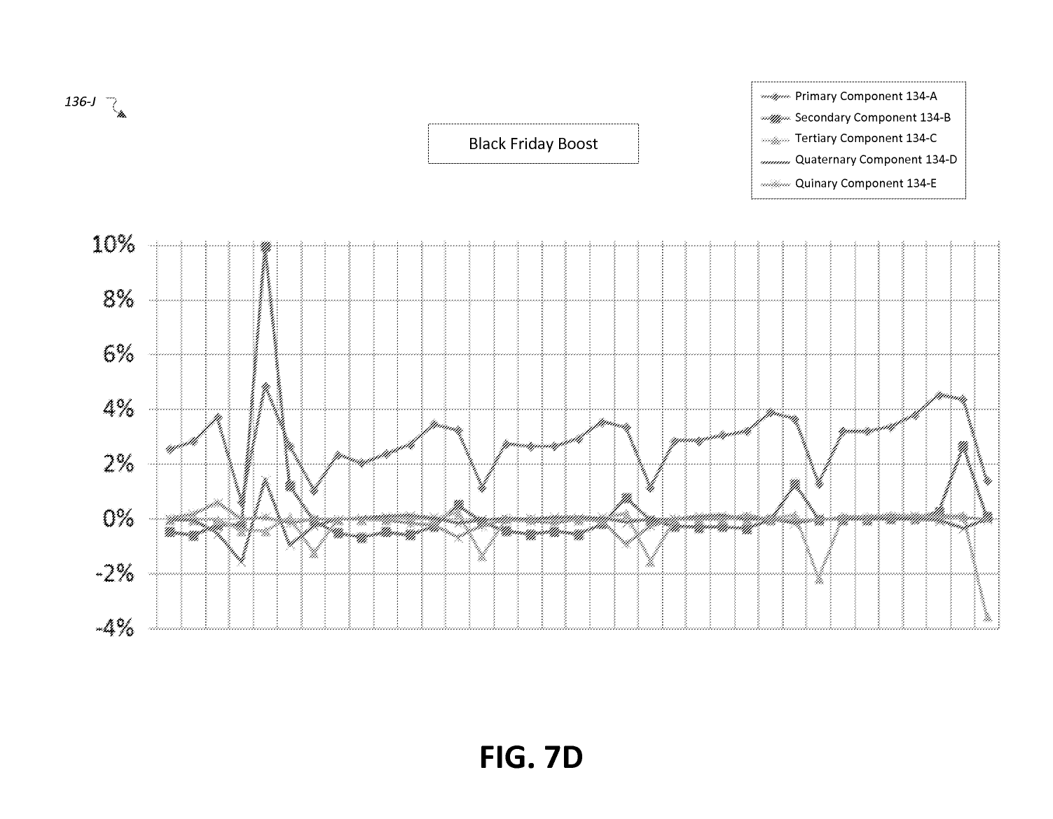

FIGS. 7A-7D each illustrate an exemplary report 136 depicting additional information that may be identified from analysis of variations in the feature components 134 of a plurality of points of interest. For example, the report 136-G illustrates an unusual downward spike in a quaternary component 134-D of a point of interest analysis for a geographic area, where the downward spike is consistent with the date of a relatively important home sports event. As another example, the report 136-H illustrates an unusual downward emphasis in a tertiary component 134-D of a point of interest analysis for a geographic area, where the downward emphasis coincides with a holiday celebrated by only a relatively small minority of persons (e.g., Hanukkah in the illustrated example). As a further example, the report 136-I illustrates a clear separation of Saturday and Sunday weekend offsets for a period of time including the last five weeks of an exemplary year. More specifically, the Saturday bumps in traffic are represented by the secondary component 134-B, while Sunday downward offsets are represented independently by the tertiary component 134-C. Such a separation of weekend components may result in areas that impose blue laws to restrict shopping activity on Sundays. As yet a further example, the report 136-J illustrates a strong Friday boost for Black Friday included in the secondary component 134-B. By determining and reporting the feature components 134, these differences may be identified in traffic count data and used to inform and predict various aspects of traffic behavior.

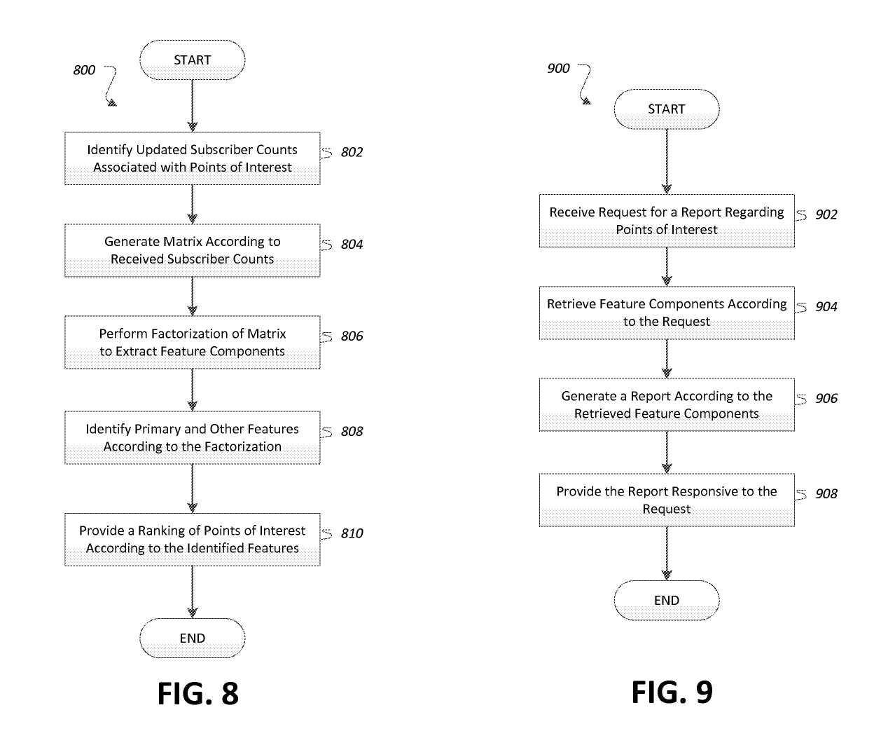

FIG. 8 illustrates an exemplary process 800 for determining feature components 134 for points of interest data 102 based on collected data from subscriber network 106 devices. The process 800 may be performed for example, by point of interest modeling device 124 in communication with a data warehouse 122 and executing a feature identifier module 132.

At block 802, the point of interest modeling device 124 identifies updated subscriber count data 130 associated with point of interest data 102. For example, the feature identifier module 132 may identify in aggregate subscriber data 128 received from the data warehouse 122, a number of subscribers whose location attributes 112 are indicative of particular points of interest in a geographical area within a period of time.

At block 804, the point of interest modeling device 124 generates a matrix 202 according to the received subscriber count data 130. For example, as illustrated in FIG. 2, the feature identifier module 132 of the point of interest modeling device 124 may create the matrix 202 to include subscriber count data 130 for one or more points of interest over multiple periods of time. As one possibility, each row of the matrix 202 may represent a count of subscriber traffic for a points of interest, each column of the matrix 202 may represent a single period of time of counts across the one or more points of interest, and each cell of the matrix 202 may represent a subscriber count data 130 amount for the given point of interest and period of time.

At block 806, the point of interest modeling device 124 performs factorization of the matrix 202 to extract feature components 138. For example, the feature identifier module 132 may perform principal component analysis using singular value decomposition on the matrix 202.

At block 808, the point of interest modeling device 124 identifies primary and other features components 138 according to the factorization. For example, the feature identifier module 132 may interpret the columns of data resulting from the principal component analysis to determine features components 138 of the information regarding the matrix 202 as a sum of a rank-1 layers. For instance, the first layer may explain the data as a first approximation, the second layer corrects the first approximation by adding and removing values that are smaller on average than for the first layer and the third layer corrects that by adding and removing still smaller values, and so on. In some cases, only a subset of the layers are considered, such that the considered layers approximate at least a minimum percentage of the variation in the overall data set (e.g., 90% of the variation).

At block 810, the point of interest modeling device 124 provides a ranking points of interest according to the identified features components 138. For example, the feature identifier module 132 may rank the points of interest by magnitude of one or more of the feature component 134. After block 810, the process 800 ends.

FIG. 9 illustrates an exemplary process 900 for providing reports 136 based on determined feature components 134. As with the process 800, the process 800 may be performed by point of interest modeling device 124 in communication with a data warehouse 122 and executing a feature identifier module 132.

At block 902, the point of interest modeling device 124 receives a request for a report 136 regarding points of interest. For example, a business owner of a plurality of points of interest or a marketer may request a report 136 related to the traffic flows of points of interest within a specified geographic area and period of time. As one possibility, the marketer may request a report 136 for coffeehouse locations in New York City or New York State.

At block 904, the point of interest modeling device 124 retrieves feature components 134 according to the request. For example, the point of interest modeling device 124 may perform a process such as the process 800 to determine the feature components 134. As another example, the point of interest modeling device 124 may retrieve previously determined feature components 134 from storage accessible to the point of interest modeling device 124.

At block 906, the point of interest modeling device 124 generates a report 136 according to the retrieved feature components 134. For example, the report generator module 138 of the point of interest modeling device 124 may create a report 136 such as one of the reports 136-A through 136-I discussed in detail above.

At block 908, the point of interest modeling device 124 provides the report 136 responsive to the request. After block 908, the process 900 ends.

Thus, by performing principal component analysis on subscriber counts data 130 determined based on subscriber network 106 activity, the point of interest modeling device 124 may identify feature components 134 in the traffic patterns at the points of interest. Using the feature components 134, the point of interest modeling device 124 may generate reports 136 indicative of a model of customer behavior may be used to accurately predict future traffic flows for various points of interest. As some examples, the generated reports 136 may indicate information regarding the points of interest such as: a busiest day of the week, a slowest day of the week, an overall weekly “beat” traffic pattern, a weekend variation in subscriber counts data 130, a holiday variation in the subscriber count data 130, effects of localized events on the subscriber count data 130, and effects of variation in holiday celebration in the subscriber counts 130.

A marketer or business may configure the point of interest modeling device 124 to provide reports 136 to a subscriber identifier 108 of the marketer or business. For instance, a business may configure the point of interest modeling device 124 to provide reports 136 to the business regarding store locations of the business in a geographic area, or reports 136 regarding traffic across a category of points of interest and geography in which the business operates. By using the reports 136, a marketer or business owner may be actively notified of customer demand, thereby allowing the marketer or business to identify past and predict future traffic flows at various points of interest, using previously unavailable sources of information to accurately model patterns of customer behavior.

Moreover, the point of interest modeling device 124 may further be configured to provide notifications regarding suggested courses of action based on the report 136 data. As one possibility, the point of interest modeling device 124 determine, based on the reports 136, that the business should be notified to consider adjusting staffing hours to accommodate identified fast and slow period of traffic (e.g., days or hours that require additional staffing or days or hours for which staffing may be reduced). As another possibility, based on an identification of unexpectedly large or small traffic flows at certain points of interest, the point of interest modeling device 124 may determine to notify the business to adjust an amounts of merchandise to have on hand at the points of interest to handle expected customer demand at various points of time during the week. As another example, a business may configure the report generator module 138 to provide a notification when traffic count information varies from typical values, such as by a threshold percentage or other amount from that of a previous reporting period or average across multiple previous reporting periods. For instance, a business may configure the report generator module 138 to provide a subscriber identifier 108 with a notification when a traffic level for a point of interest varies by more than 15 percent from the traffic level of the same point of interest and day for the prior week. As another possibility, a business may configure the report generator module 138 to provide a subscriber identifier 108 with a notification when a traffic level for a point of interest outperforms or underperforms its relative ranking among other points of interest within a geographic area by more than a specified percentage, rank or traffic amount.

These notifications, including the suggested courses of action based on the report 136 data, may be provided from the point of interest modeling device 124 to businesses and marketers in various ways. For instance, the notifications of suggested courses of action may be provided to a set of one or more subscriber identifiers 108 associated with the business by text message (e.g., via short message service (SMS), instant message, etc.). As another possibility, these notifications may be provided to the business as calendar entries automatically added for those days where a course of action is suggested by the point of interest modeling device 124 (e.g., a day for which inventory levels or staffing levels may require adjustment based on the reports 136). As yet a further possibility, these notifications may be provided as e-mail messages to a set of one or more e-mail addresses of the business configured with the point of interest modeling device 124 to receive the notifications. Still further, the notifications may be provided to a notification application executed by a subscriber device connected to the subscriber network 106, where a subscriber identifier 108 of the subscriber device is configured with the point of interest modeling device 124 to receive the notifications.

In general, computing systems and/or devices, such as the data warehouse 122 and point of interest modeling device 124, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices such as the such as the data warehouse 122 and point of interest modeling device 124 generally include computer-executable instructions, such as the instructions of the feature identifier module 132 and report generator module 138, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device configured to execute a software application on a processor of the computing device to provide operations comprising:
identifying, from aggregate subscriber data generated from subscriber network data records received from a subscriber network and representing usage of the subscriber network by subscriber devices, subscriber count data for a plurality of points of interest within a geographical area over a period of time;
generating a matrix according to the identified subscriber count data, the matrix including counts per subset of the period of time arranged according to subset of the period of time and point of interest;
performing a factorization of the matrix of subscriber counts to extract feature components of the subscriber count data;
identifying at least a primary feature component and a secondary feature component according to the factorization;
providing a ranking of at least a subset of the points of interest according to at least one of the primary feature component and the secondary feature component; and
sending a notification over the subscriber network to at least one of the points of interest, the notification including a suggested course of action determined according to the ranking

2. The computing device of claim 1, wherein the primary feature component is indicative of an overall variation in subscriber counts for each of the plurality of points of interest, and the software application is further executable by the computing device to provide operations comprising identifying, according to the primary feature component, at least one of a busiest day of the week and a slowest day of the week of a point of interest of the plurality of points of interest.

3. The computing device of claim 1, wherein the secondary feature component is indicative of a further variation in the subscriber counts independent of the primary feature component, and the software application is further executable by the computing device to provide operations comprising identifying, according to the secondary feature component, at least one of a weekend variation in subscriber counts and a holiday variation in the subscriber counts.

4. The computing device of claim 1, further comprising identifying at least one tertiary feature according to the factorization, wherein the tertiary feature is indicative of a further variation in the subscriber counts independent of the primary feature component and the secondary feature component, wherein the software application is further executable by the computing device to provide operations comprising identifying, according to the tertiary feature, at least one of a localized event and a variation in holiday celebration in the subscriber counts.

5. The computing device of claim 1, wherein the subset of the period of time is one of an hour, a day-part, or a day, the geographical area is one of a zip code, a section of a city, a city, a state, and a nation, and the plurality of points of interest are included in the matrix as being within a point of interest category.

6. The computing device of claim 1, wherein the factorization is performed according to principal component analysis using singular value decomposition.

7. The computing device of claim 1, further comprising:
receiving a request for a report regarding the plurality of points of interest within the geographical area over the period of time;
generating the report according to the identified feature components; and
providing the report responsive to the request.

8. A method, comprising:
identifying, from aggregate subscriber data generated from subscriber network data records received from a subscriber network and representing usage of the subscriber network by subscriber devices, subscriber count data for a plurality of points of interest within a geographical area over a period of time;
generating, by a computing device executing a feature identifier module, a matrix according to the identified subscriber count data, the matrix including counts per subset of the period of time arranged according to subset of the period of time and point of interest;
performing, by the computing device, a factorization of the matrix of subscriber counts to extract feature components of the subscriber count data;
identifying, by the computing device, at least a primary feature component and a secondary feature component according to the factorization;
providing a ranking of at least a subset of the points of interest according to at least one of the primary feature component and the secondary feature component; and
sending a notification over the subscriber network to at least one of the points of interest, the notification including a suggested course of action determined according to the ranking

9. The method of claim 8, wherein the primary feature component is indicative of an overall variation in subscriber counts for each of the plurality of points of interest, and the software application is further executable by the computing device to provide operations comprising identifying, according to the primary feature component, at least one of a busiest day of the week and a slowest day of the week of a point of interest of the plurality of points of interest.

10. The method of claim 8, wherein the secondary feature component is indicative of a further variation in the subscriber counts independent of the primary feature component, and the software application is further executable by the computing device to provide operations comprising identifying, according to the secondary feature component, at least one of a weekend variation in subscriber counts and a holiday variation in the subscriber counts.

11. The method of claim 8, further comprising identifying at least one tertiary feature according to the factorization, wherein the tertiary feature is indicative of a further variation in the subscriber counts independent of the primary feature component and the secondary feature component, wherein the software application is further executable by the computing device to provide operations comprising identifying, according to the tertiary feature, at least one of a localized event and a variation in holiday celebration in the subscriber counts.

12. The method of claim 8, wherein the subset of the period of time is one of an hour, a day-part, or a day, the geographical area is one of a zip code, a section of a city, a city, a state, and a nation, and the plurality of points of interest are included in the matrix as being within a point of interest category.

13. The method of claim 8, wherein the factorization is performed according to principal component analysis using singular value decomposition.

14. The method of claim 8, further comprising:
receiving a request for a report regarding the plurality of points of interest within the geographical area over the period of time;
generating the report according to the identified feature components; and
providing the report responsive to the request.

15. A non-transitory computer-readable medium tangibly embodying computer-executable instructions of a software program, the software program being executable by a processor of a computing device to provide operations comprising:
identifying, from aggregate subscriber data generated from subscriber network data records received from a subscriber network and representing usage of the subscriber network by subscriber devices, subscriber count data for a plurality of points of interest within a geographical area over a period of time;
generating a matrix according to the identified subscriber count data, the matrix including counts per subset of the period of time arranged according to subset of the period of time and point of interest;
performing a factorization of the matrix of subscriber counts to extract feature components of the subscriber count data;
identifying at least a primary feature component and a secondary feature component according to the factorization;
providing a ranking of at least a subset of the points of interest according to at least one of the primary feature component and the secondary feature component; and
sending a notification over the subscriber network to at least one of the points of interest, the notification including a suggested course of action determined according to the ranking

16. The computer-readable medium of claim 15, wherein the primary feature component is indicative of an overall variation in subscriber counts for each of the plurality of points of interest, and the software application is further executable by the computing device to provide operations comprising identifying, according to the primary feature component, at least one of a busiest day of the week and a slowest day of the week of a point of interest of the plurality of points of interest.

17. The computer-readable medium of claim 15, wherein the secondary feature component is indicative of a further variation in the subscriber counts independent of the primary feature component, and the software application is further executable by the computing device to provide operations comprising identifying, according to the secondary feature component, at least one of a weekend variation in subscriber counts and a holiday variation in the subscriber counts.

18. The computer-readable medium of claim 15, further comprising identifying at least one tertiary feature according to the factorization, wherein the tertiary feature is indicative of a further variation in the subscriber counts independent of the primary feature component and the secondary feature component, wherein the software application is further executable by the computing device to provide operations comprising identifying, according to the tertiary feature, at least one of a localized event and a variation in holiday celebration in the subscriber counts.

19. The computer-readable medium of claim 15, wherein the subset of the period of time is one of an hour, a day-part, or a day, the geographical area is one of a zip code, a section of a city, a city, a state, and a nation, and the plurality of points of interest are included in the matrix as being within a point of interest category.

20. The computer-readable medium of claim 15, wherein the factorization is performed according to principal component analysis using singular value decomposition.

21. The computer-readable medium of claim 15, further comprising:
receiving a request for a report regarding the plurality of points of interest within the geographical area over the period of time;
generating the report according to the identified feature components; and
providing the report responsive to the request.
